(19) United States
(12) Patent Application Publication
(10) Pub. No.: US 2005/0154608 A1
(43) Pub. Date: Jul. 14, 2005

(54) Digital media distribution and trading system used via a computer network

(75) Inventors: Joseph V. Paulson, Austin, TX (US); Amit Likhyani, Austin, TX (US); Amir Rostami, Austin, TX (US)

Correspondence Address: PILLSBURY WINTHROP SHAW PITTMAN LLP, 725 S. FIGUEROA STREET, SUITE 2800, LOS ANGELES, CA, 90017, US

(73) Assignee: FAIR SHARE DIGITAL MEDIA DISTRIBUTION

(21) Appl. No.: 10/970,361

(22) Filed: Oct. 21, 2004

Related U.S. Application Data
(60) Provisional application No. 60/513,105, filed on Oct. 21, 2003.

(51) Int. Cl. G06F 17/60

(52) U.S. Cl. 705/1

(57) ABSTRACT

A digital media file sharing system includes a fair share server, a user computer, and a second user computer. The fair share server includes a user library information database and a media library, the media library storing digital media files. A user computer includes a user computer media library and the user computer media library stores user digital media files. A second user computer includes a second user computer media library and requests the downloading of a selected digital media file from the user library information database. The second user computer downloads the selected digital media file from the user computer media library. The user computer is allocated a credit in the payment database of the fair share server for providing the selected digital media file to the second user computer.

### RELATED APPLICATION

This application claims priority to U.S. provisional patent application Ser. No. 60/513,105, filed Oct. 21, 2003.

### BACKGROUND OF THE INVENTION

Currently, major record labels lose extensive revenue because of pervasive and widespread illegal file sharing, which takes place via the Internet. Up to 20 million Americans are file sharing music and more than 40 million have downloaded music at least once. Estimates that are 90 percentage of the content moving through file sharing networks is illegal.

No entity, including record labels, generate revenue from this illegal activity. Those who share files illegally do so through unmonitored peer-to-peer transactions. Those who pay for downloaded music do so legally at the end of the transaction. Digital music customers are faced with a choice, download illegally with possible legal repercussions or download legally, without any incentives.

Legal downloading of music files generates profits for the major record labels. However, these profits are a small percentage of the potential profits that a file-sharing network with legal content, total content, and user incentives would be able to generate. According to some studies, there is a potential to generate $2.1 billion, or 17% of the music business by 2007.

If the user is downloading files or music illegally, the user risks being caught violating copyright laws and facing heavy criminal fines. Specifically, the Recording Industry Association of America (RIAA) is filing suit against individual users of current file sharing networks for copyright infringement. This prosecution is alienating file sharing users. Alternatively, there is an offering of pay per download services at web sites such as buymusic.com and Apple iTunes.com. Although this is an economical solution, the user has no financial incentive to file share the user's legally obtained files with other users.

### SUMMARY OF THE INVENTION

Fair Share's digital media distribution system and method incorporate trading from the culture of online file swappers into a centralized, controlled bank of media files. The centralized and controlled media bank is created by using digital media or music files that copyright holders have given permission for Fair Share to utilize. Each media file in the centralized media bank is coded with a unique fingerprint that allows it to be tracked throughout the Fair Share system. In addition, files having a unique fingerprint can be stored at user's computers and also tracked through the Fair Share system. This tracking allows the operator of the system, and indirectly the record labels and/or copyright holders, to know the number of times the song or file has been downloaded. In order to access the central music bank and other users' files (composed only of legally obtained files), a new user can create an account through Fair Share's website and download the file distribution software. After downloading the file distribution software, the user can download digital media or music files.

### BRIEF DESCRIPTION OF THE DRAWINGS

FIG. 1 illustrates initial interactions with a Fair Share centralized music bank web site according to an embodiment of the invention;

FIG. 2 illustrates downloading of a song from the Fair Share web site according to an embodiment of the present invention;

FIG. 3 illustrates downloading of a song from a second user's computer according to an embodiment of the invention;

FIG. 4 illustrates uploading of digital media/music files into the Fair Share music library 130;

FIG. 5 illustrates the incorporation of a digital music file into the Fair Share digital media and distribution system according to an embodiment of the present invention;

FIG. 6 illustrates a process a customer or user follows to download or to share digital music files according to an embodiment of the invention; and

FIG. 7 illustrates a standard layout of an ID3 tag.

### DETAILED DESCRIPTION OF THE INVENTION

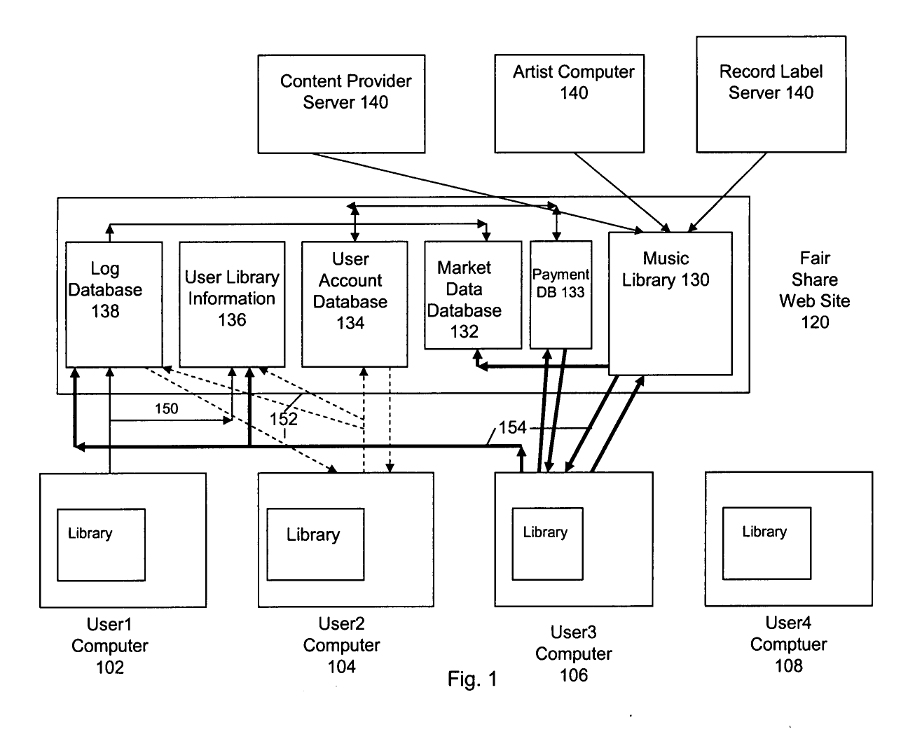

FIG. 1 illustrates initial interactions with a Fair Share centralized music bank web site according to an embodiment of the invention. The Fair Share system 100 includes content providers, record labels, or artists 140, a centralized Fair Share web site 120, and a plurality of users 102 104 106 and 108. The centralized Fair Share web site 120 may include a log database 138, a user library information database 136, a user account database 134, a market data information database 132, a payment database 133, and a music library 130. In various parts of the specification, digital music files may be utilized illustratively. This invention equally applies to any digital media files including, but not limited to, software programs, video games, movies, photographs, etc.

The log database 138 tracks movements and behavior of a user that visits the Fair Share web site. The user library information database 136 provides lists of the digital media files that are available for download. The user library information database 136 includes information for media files located not only in the music library 130 of the Fair Share web site but also in the libraries of any of the registered user computers 102 104 106 and 108. The user account database 134 registers users and keeps track of the user's downloads as well as financial payment information. The market data database 132 includes records of everything that users or customers purchase and/or download from the Fair Share web site 120. The payment database 133 keeps all payment records of each user, tracks how the revenue or payments are divided between Fair Share, the record labels (or content providers and artists), and the users that allow downloading. The payment database 133 may process financial transactions and credit accounts that are established for participating users, record labels, content providers, or artists. The music library 130 is the physical location where the digital files are loaded for the Fair Share web site.

Under certain operating conditions, a user may log into the Fair Share web site 120 and browse the user library information database 136 for lists of available downloaded songs. Under these operating conditions, the user does not create an account on the Fair Share web site 120 and does not download the Fair Share software to the user computer 102 104 106 108. As illustrated in FIG. 1, for example, arrows 150 highlight how a user utilizing the user1 computer 102 logs into the Fair Share web site 120 and is coupled to the log database 138. The log database 138 monitors the actions and behavior of the user. The user is also coupled to the user library information database 136 in order to browse the available digital music files. When logging on to the Fair Share web site 120, if the user, e.g., user1, does not have an account, then the user logs in as an anonymous user through the log database 138. Even if the user does not provide any personal information, the log database 138 tracks the user's activity on the fair share web site 120 and stores this information in the log database 138.

Under certain operating conditions, a user may log into the Fair Share web site 120 and create an account. Under these operating conditions, the user logs into the log database 138 of the fair share web site. The log database 138 tracks the activity of the user. This is illustrated in FIG. 1 by the dotted lines 152. As discussed above, a user may browse the listings of digital music file by logging into the user library information database 136. If the user likes the digital music file selection provided by the Fair Share web site 120, in one embodiment of the invention, the user may create an account on the Fair Share web site 120. In order to create the account on the Fair Share web site, the user or user computer 104 may enter the account database 134 of the Fair Share web site 120. The user can enter personal information, e.g., name, billing address, billing information (credit card, checking account, etc.) In an embodiment of the invention, the billing portion of the personal information may be transferred from the user account database 134 to the payment database 133. The user may also enter information regarding the computer they are using, e.g., connection type, storage capabilities, software programs downloaded, etc.) In this embodiment of the invention, the user may download Fair Share software from the Fair Share web site to the user computer. The Fair Share software to be downloaded may be stored originally in the account database 134. Alternatively, the user may receive a copy of the Fair Share software via a mailed storage medium, e.g., a CD, a floppy disk, or a DVD and may load it on the user computer, e.g., user2 computer 104. In embodiments of the invention, the user does not have to have an account to download the Fair Share client software. The user needs to establish an account if the user wants to download a digital music file.

Under other operating conditions, the user, who has already established an account, may login to the Fair Share web site 120 and download a music file. As illustrated by the bold line 154, in FIG. 1, user3, utilizing user computer 3 106, logins to the Fair Share web site 120 and originally is directed to the log database 138, which tracks the behavior of user 3 on the Fair Share web site 120. User3 also logs into the user or music library information database 136 and identifies a digital music file the user, via user3 computer 106, would want to download. User3 selects the digital music file he or she would like to download and then is directed to the music library or music library database 130. Under certain operating conditions, the Fair Share web site may request to receive payment from the customer or user, e.g. user3. As illustrated in FIG. 1, the user3 computer 106 interacts or communicates with the payment database 133 to provide billing information, if the Fair Share system does not have the payment information, and to complete the transaction. The payment database 133 may also divides up the payment between the interested parties, i.e., record labels (content providers, artists, etc.), Fair Share and other users. The digital music file is downloaded from the music library on the Fair Share web site to the music library 160 on the user computer 106. After the digital music file is downloaded to the user computer music library 160, a Fair Share fingerprint of the digital music file is modified to identify that this copy of the digital music file is located and owned by the user who downloaded the file. The Fair Share fingerprint is discussed below. The Fair Share fingerprint prevents another user from comprising the security of the Fair Share system by attempting to upload or file-share music files that are not legally owned or that the copyright owners do not want these digital music files uploaded into the Fair Share system. After the digital music file is downloaded, the market data database 132 records and tracks what the user, e.g., user3 computer, purchased and downloaded from the Fair Share web site.

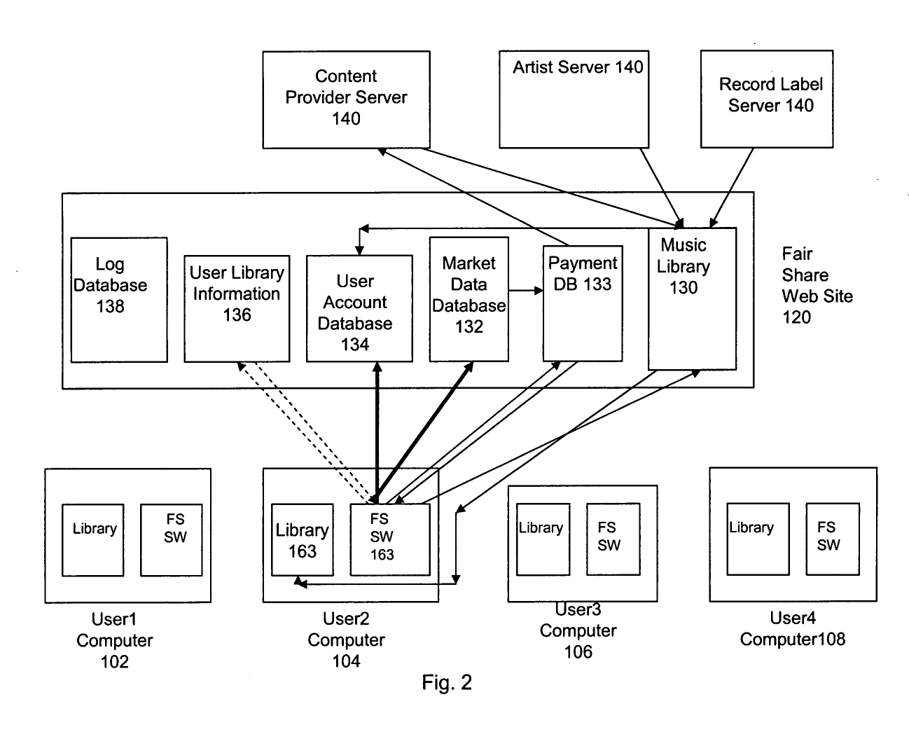

In various parts of the specification, digital music files may be utilized illustratively. This invention equally applies to any digital media files including, but not limited to, software programs, video games, movies, photographs, etc. FIG. 2 illustrates downloading of a song from the Fair Share web site according to an embodiment of the present invention. A user who is registered with the Fair Share web site 120, e.g., user2 via the user 2 computer 104, may login to the Fair Share web site 120 and interact with the user library information module 136 in order to determine which of the copyrighted or other songs are available for download. Under certain operating conditions, the user library information module 136 providers the user, e.g., user 2, with a list of songs. The user may select one of the list of songs as the song or digital music selection that the user would like to download utilizing the user2 computer 104.

Under other operating conditions, the user identifies a specific song that the user would like to download and sends a query from the user2 computer 104 to the user library information module 136 and the user library information module 136 identifies if the Fair Share digital music distribution system has the requested song and whether other users may have copies of the song available for download. Under these operating conditions, the user (via the user2 computer 104) would select a copy of the song to be downloaded from the Fair Share web site 120, specifically the music library 130 of the Fair Share web site 120.

After the song(s) are selected or chosen, the Fair Share web site 120 downloads the song(s) from the music library 130 of the Fair Share web site 120 to the music library 162 of the user computer, e.g., user2 computer 104. The user computer performs a verification to identify whether or not the download has been successful. In one embodiment of the invention, the user computer 104 may perform a checksum of the digital music file to verify that the file has been downloaded correctly. In another embodiment of the invention, the Fair Share web site 120 may perform a hash algorithm on the digital music file before download and transmit a hash value with the downloaded song. The client Fair Share software 163, which is loaded on the user computer 104, may include the same hash algorithm and once the song has been downloaded, the client Fair Share software 163 may perform the same hash algorithm to generate a downloaded hash value. The downloaded hash value may be compared to the original hash value to verify that song or digital music file has been downloaded correctly.

If the download of the song is successful, the song may be stored in the user computer music library, e.g., user2 music library 162. The user computer 104 may notify a market data database 132 of the Fair Share web site 120. As noted before, the market data database 132 tracks the downloads and purchases each user or customer performs. Under certain operating conditions, the market data database 132 may notify a payment database 133 of the Fair Share web site 120, which proceeds with receiving payment from the user for the correctly downloaded song. Under other operating conditions, the Fair Share web site 120 may request payment information from the user2 computer 104 before downloading of the digital music file. If the download is not successful, then the Fair Share client software 163 deletes the song from the user library 162 of the user2 computer 104 and no payment is made from the user to the Fair Share digital music distribution system.

The user computer also transmits information to the user library information module 136 to identify that user computer music library, e.g., user2 music library 163 has a copy of the downloaded song. This means that at least both the music library 130 of the Fair Share web site 120 and the music library 162 of the user2 computer 104 both have copies of the song, and that both sites can download the song to additional users. The user library information database 136 records include information to represent the at least two locations for this song.

Under these operating conditions, the Fair Share web site payment database 133 may determine how the payment that is received from the user should be divided up or split up. The Fair Share system operator receives a portion of the payment received from the customer and the record label, content provider, or song provider receives a second portion of the payment. Under certain operating conditions, the record label may receive 75% of the payment, 65% of the payment, or 50% of the payment with the Fair Share system operator receiving the remaining portion of the payment.

The payment database 132 may accept payment from the user via a credit card transaction or by a bank transaction, such as electronic deductions from checking accounts or savings accounts. The payment database 133 monitors all payments to all parties (1) the record labels, artists, content providers, etc., and (2) the users who make the songs available for download. In an embodiment of the invention, the payment database 133 may also handle the actual payment transaction.

Payments to the record labels, artists, content providers, etc., may occur on a periodic basis, depending on the arrangement specified in the agreement between the content providers and the Fair Share system operator. Illustratively, the payments may occur on a weekly, monthly, quarterly, or annual basis. The timing of the payments may depend on how many songs the content providers has available via the Fair Share digital music distribution system and how often the songs are downloaded, i.e., the revenue that the content provider is pushing through the Fair Share digital music system. In one embodiment of the invention, the payment database 133 may actually transmit a payment to the content provider 140 around the time of purchase once the download of the song has been successfully completed to the user computer, e.g., user computer 102, 104, 106, 108. This may occur if the cost of processing this transaction is insignificant as to the revenue generated from the download of the song.

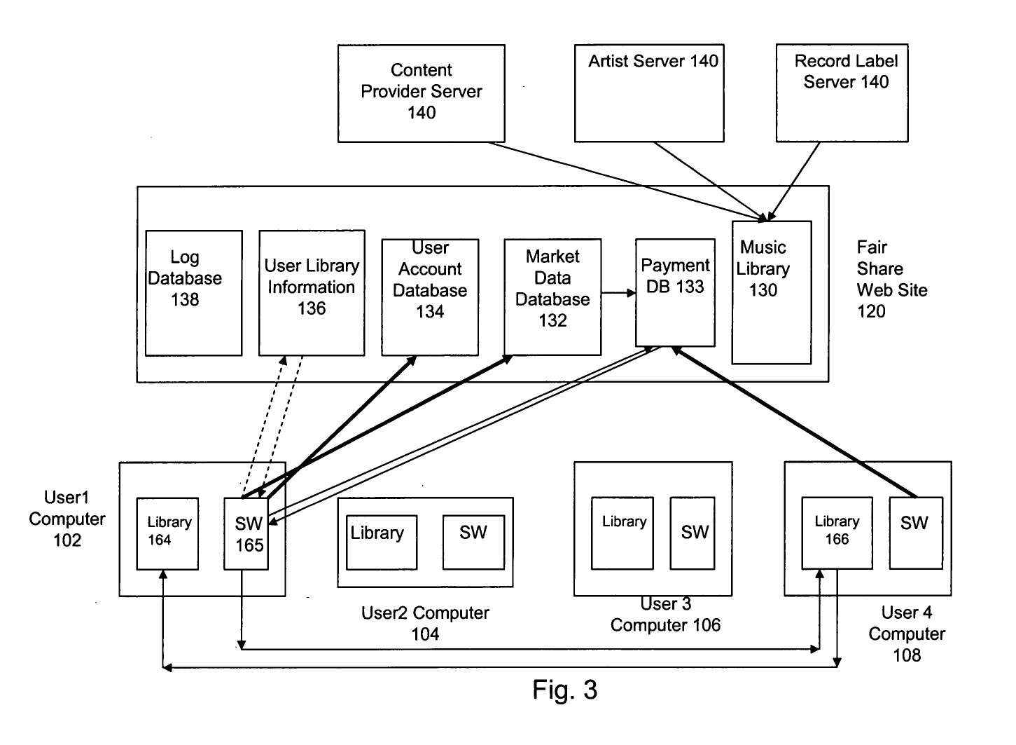

FIG. 3 illustrates downloading of a song from a second user's computer according to an embodiment of the invention. The user, e.g. user 1 via the user computer 102, may contact the user library information module 136 of the Fair Share web site 120 to determine if a certain song is available for download via the Fair Share digital music distribution system. The user library information database 136 may identify that the requested song is available at both the Fair Share web site 120 and also via user4's computer, e.g., the music library 166 on user4's computer 108. The user, via the user computer 102, selects to download the requested song from user4's computer 108. Under certain operating conditions, the user, e.g., user1, may wish to download a media file and the only available media file on the Fair Share network, as identified by the user library information module 136, may be located on another user's computer, e.g., user4 computer 108. Under other operating conditions, the user library information module 136 may be configured to provide only user computer download possibilities if there are user computer music libraries which have copies of the selected song. Under other operating conditions, a user may wish to download a media file and all other users, except for one user computer music library, and the Fair Share music library 130 may be busy serving other customers. Thus, if the user wants to download from the Fair Share music library 130, the user or customer may have to wait. If the user does not wish to wait, the user or customer may download the requested song from the user computer music library where there is no wait, e.g., user4 computer music library 166.

The song is downloaded to the user's computer 102 music library 164 from user4's music library 166. The Fair Share software 165 on the user's computer verifies that the song has been successfully downloaded from the user4 computer music library 166. If the download has been successful, the user computer 102 notifies the market data database 132 of the Fair Share web site. The market data database 132 may notify the payment database 133 to collect payment from the user, e.g., user1. Under certain operating conditions, the user computer 102 may also notify the payment database 133 of the Fair Share web site 120, which receives payment from the user, e.g., user1, for the downloaded song or digital music selection. The user computer, e.g., user1 computer 102, also notifies the user library information module 136 that the requested song is now available for download from the user computer's music library 164. In this embodiment of the invention, the requested song is now available in at least three locations, i.e., Fair Share web site music library 130, user4 computer music library 166, and the user computer music library 163. Under certain operating conditions, the user4 computer 108 (in order to receive proper credit) may identify to the payment database 133 of the Fair Share web site 120 that it has downloaded a song to another user as verification that it was the downloading site. The payment database 133 may then determine how to divide up the revenue once it has been received. Under certain operating conditions, the record label, content provider, or artist may receive a first portion of the payment, the downloading site, i.e., user4, may receive a second portion of the payment, and the Fair Share system operator may keep a third portion of the payment. In an embodiment of the invention, the content provider may receive between 40-75% of the payment, the Fair Share provider may keep between 15-40% of the payment, and the downloading site may receive 10-25% of the payment.

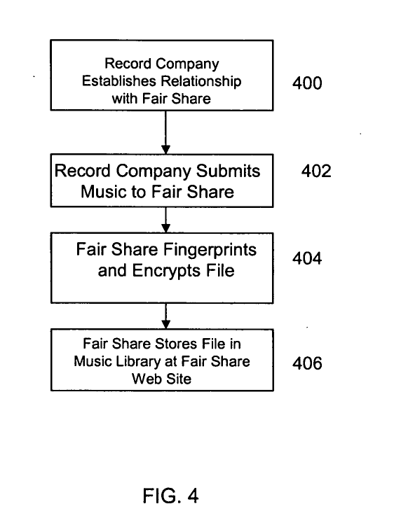

FIG. 4 illustrates uploading of digital media/music files into the Fair Share music library 130. Fair Share and a record company sign 400 an agreement to allow digital music files, e.g., MP3 files, to be downloaded by users or members of the Fair Share media distribution system. The record company or label may then download 402 digital media or music files of a plurality of digital media/music files to the Fair Share web site, specifically the music library 130 of the Fair Share web site 120. Alternatively, the record label may send the operator of the Fair Share web site 120 a CD, DVD, memory card with the songs that are to be stored in the Fair Share music library 130.

Under certain operating conditions, the Fair Share web site may add the fingerprint 404 or header to the digital music file. In addition, the Fair Share system may encrypt 404 the digital music file to create an encrypted digital media file. The Fair Share system may store the encrypted digital music file in the music library database 130 or music library of the Fair Share music system.

After a selected media file or selected media files are downloaded into the Fair Share music library 130, the selected media file(s) has header information, e.g., a Fair Share fingerprint, added to an ID tag portion of an MP3 digital music file. The header information identifies that the MP3 digital music file is a Fair Share file. In one embodiment of the header information, the header information provides information about the artist and record label.

The Fair Share system then encrypts the header information, e.g., the Fair Share fingerprint, to help protect the contents of the header from illegal use. The Fair Share system also performs a MD5 hash of the digital music file and stores the calculated value of the MD5 hash. This calculated hash value is later utilized by the Fair Share software to verify that the downloaded file is a valid file. In other words, the Fair Share software either 1) downloads this hash value along with downloading the song or 2) retrieves the hash value from the music library. The user computer calculates an MD5 hash value of the downloaded music file and compares the downloaded music file's calculated hash value to the FS database music file's hash value to verify it is a valid file.

In embodiments of the invention, the Fair Share system may also encode the MP3 file before it is stored in the Fair Share music library, which gives users a choice between qualities Illustratively, the qualities may be at what quality the user or customer may wish to encode their song, e.g., CD quality, Radio quality, Tape quality, etc. Under certain operating conditions, the Fair Share system could encrypt the MP3 file using a Digital Rights Management (DRM) key or code that has been requested by the record label. The above-identified protections may make it more difficult to misuse the file. In addition, the above-identified protections allow the Fair Share system to track a Fair Share digital music file when running a site audit on another file-sharing site.

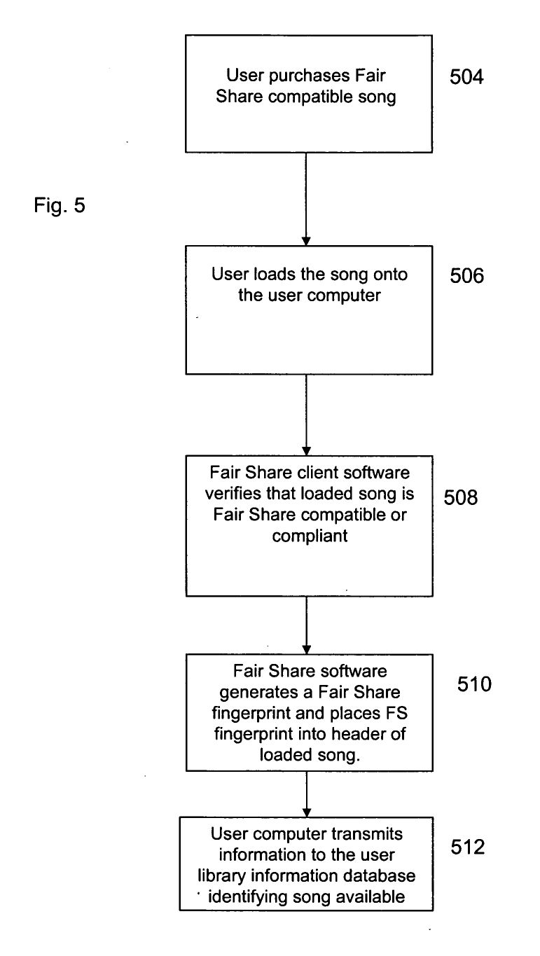

FIG. 5 illustrates the incorporation of a digital music file into the Fair Share digital media and distribution system according to an embodiment of the present invention. Under certain operating conditions, a user may purchase a Fair Share-compatible song or songs and wish to notify the Fair Share digital music distribution system that the FS-compatible song(s) is available on the user's computer and available through the Fair Share network. After the user purchases 504 the song which is Fair Share-compatible and loads 506 the song on the user computer. Fair Share client software, loaded on the user's computer, verifies 508 that the song or songs are FS-compatible.

The Fair Share software on the user's computer may generate 510 a Fair Share fingerprint and place the fingerprint in a header that is associated with the song(s). After the fingerprint has been associated with and placed in a header that is part of the FS-compatible song(s), the user, via the user computer, transits 512 information to the Fair Share web site 120 that the FS-compatible song(s) is available for download from the user's computer. For example, the user computer 108 transmits information to the user library information database 136 identifying that a FS-compatible song is available on the user computer, e.g., the user computer 108 music library 166.

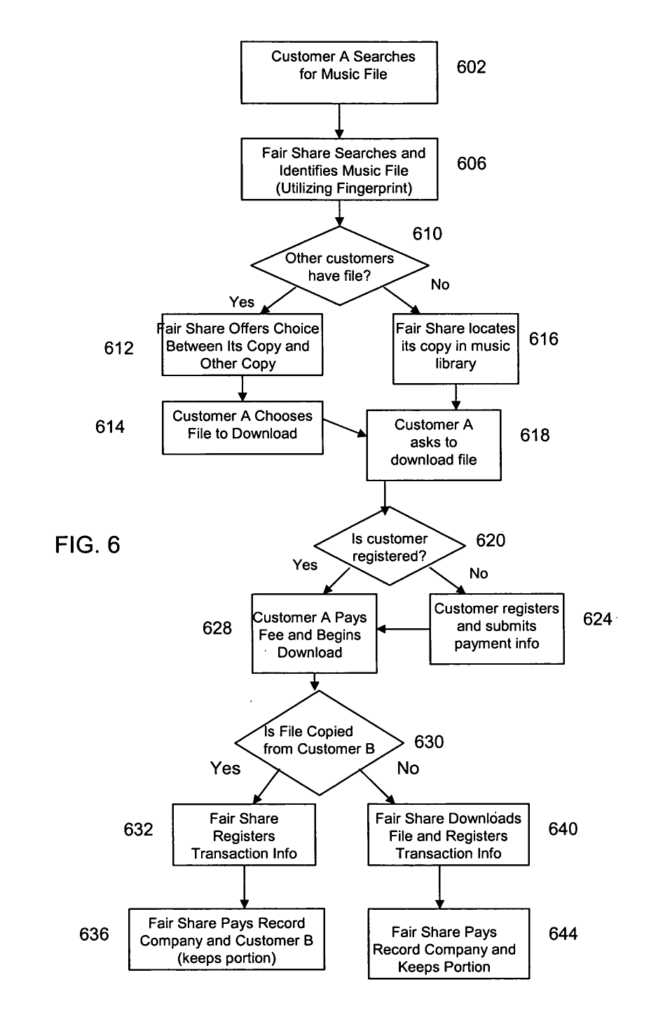

FIG. 6 illustrates a process a customer or user follows to download or to share digital music files according to an embodiment of the invention. Initially, a customer of user may search 602 the Fair Share web site for a digital music file that meet the customer's search criteria. In other words, the customer or user can attempt to find the desired music file. The Fair Share web site may utilize any type of query method in order to provide the customer or user with searching capabilities. Illustratively, the Fair Share web site could allow a user or customer to an internet search engine to retrieve digital music files.

The Fair Share web site search mechanism may locate 606 the desired music file on the Fair Share web site. The Fair Share search mechanism may identify the file by the Fair Share fingerprint or other identity mechanism. The Fair Share web site determines 610 whether other customers also have copies of the selected digital media file. Illustratively, the Fair Share web site may identify that the desired digital music file is located on the Fair Share web site and on three user's computers, e.g., user10 computer, user5 computer, and user3 computer. The Fair Share search mechanism may also identify whether or not the desired digital music or media files are presently available for download, i.e., if the user would have to wait to download the desired digital music or media file. The Fair Share search mechanism may provide the user or customer with an opportunity to select a copy of the desired digital music or media file that has not wait period associated with it, e.g., it is not currently being downloaded or updated. The desired digital music or media file could be located in another user computer media library or the Fair Share server media library. Alternatively, the customer or user could choose to wait and download the digital music or media file from a user computer music library or the Fair Share library that currently is being utilized by another individual.

If the FairShare web site 120 identifies that the other customers have a copy of selected digital music file, the Fair Share web site offers 612 the user or customer a choice between the copy of the selected digital music file in the music library 130 of the Fair Share web site and copies of the selected digital music file that are located in music libraries of other customer's computers. The user or customer selects 614 one of the digital music files to download. In other words, the user or customer selects either to download from the Fair Share web site 120 or from one of the other customer's computers. If the Fair Share web site 120 has the only copy of the selected digital music file, the FairShare web site locates 616 the copy of the selected digital music file in its database, e.g., the Fair Share music library 130.

In either case, the customer or user makes a request 618 to perform the actual download of the selected music file. The Fair Share web site determines 620 whether or not the user or customer is registered with the Fair Share music system. It is important to note that a user or customer can perform the initial search for digital music files without actually being registered with the Fair Share digital media/music distribution system.

If the customer is not registered, then the user or customer registers 624 with the Fair Share digital media distribution system. As part of this registration, the user or customer submits payment information, i.e., credit or debit card information or checking/savings account information. This payment information may be transferred from the user computer to a payment database 133 of the Fair Share web site.

If the customer is registered or becomes registered, the customer or user authorizes 628 payment, via the payment database 133, and begins to download the desired digital/media music file. Under certain operating conditions, the Fair Share web site 120 does not begin the download until the Fair Share payment database 133 has received authorization from the customer or user's selected payment mechanism, e.g., an approval from a credit card company or a check verification from the user or customer's bank.

The Fair Share web site utilizes 630 the information about where the customer or user downloaded the digital music file from in order to credit the correct accounts in an account database. In other words, the Fair Share digital media distribution system identifies whether the music was downloaded 630 from a user's media library or from the Fair Share music library. If the digital music file is to be downloaded from another user, then the Fair Share system registers 632 that transaction information. Illustratively, the Fair Share system identifies in a payment database 133 that a second user computer will be transferring a file to the first user computer, e.g., customer A. Due to the incentive system established in the Fair share system, the second user computer will receive a percentage of the revenue generated from customer A or the first customer for downloading the song.

Under the operating conditions where the digital music file is downloaded from another user, the Fair Share system will divide 636 up the revenue generated from the downloading of the song between Fair Share, the record label, and the other user. For example, if customer B's computer is utilized for downloading a song to customer A utilizing the Fair Share system, then customer B, the record label, and Fair Share will split the revenue generated from customer A. Under certain operating conditions, Fair Share may keep 15% of the revenue, credit the record company for 75% of the revenue, and credit customer B 10% of the revenue. Under certain operating conditions, the record label and or customer B, who is a member of the Fair Share media distribution network, may receive a payment from Fair Share on a periodic basis, e.g., every week or every month. In many cases, it would not be economical to make payments per transaction because the cost to download music is low $0.99 cents and it would not make economical sense to send out credits or checks for 0.10 cents or even 0.75 cents.

Under the operating conditions where the digital music file is downloaded from the music library at the Fair Share web site, after payment authorization is received, the Fair Share system begins 640 the download of the selected file and registers the transaction information. The transaction information may be registered in multiple databases in the Fair Share system. For example, the log database may be anonymously or individually monitoring the user's behavior. Additionally, the account database may be updated based on the song(s) downloaded from the Fair Share web site. If the user who receives the download would like to become part of the Fair Share digital media distribution system, then the music information library database 136 may be updated indicating that the downloaded file now resides on the user's computer and is available for download to other users' computers. After the download has been completed, the user computer may communicate with the market data database 132 to identify that a song or songs have been downloaded.

Under these operating conditions where the digital music file is downloaded from the Fair Share music library, the Fair Share digital media/music distribution system keeps a percentage of the revenue generated from the customer and credits the record label or content provider a percentage of the revenue generated from the customer. Illustratively, the Fair Share system may credit the record label 75% of the revenue generated and keep 25% if the revenue.

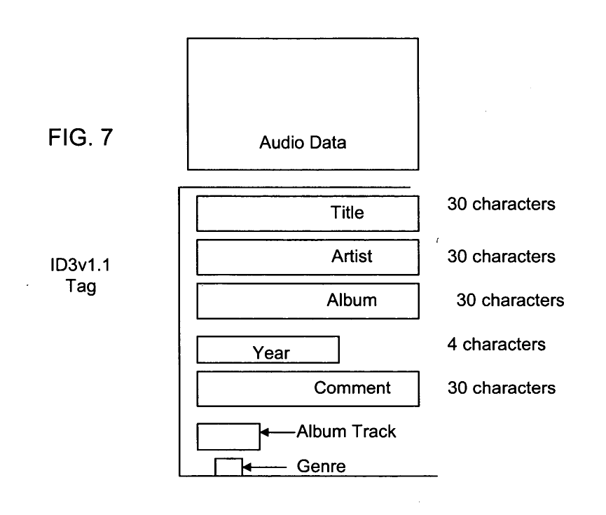

The chart below illustrates a unique identifier, or Fair Share fingerprint, according to an embodiment of the present invention. Each digital music file, e.g., MP3 file, is protected and tracked by a proprietary “fingerprint” in the Fair Share digital media/music distribution system The fingerprint identifies the file and tracks if the file is copied over to another file-sharing site. The fingerprint is added to a header that is attached to the digital media file. Illustratively, if the digital music file is a MP3 file, a standard ID3 tag is added to the end of an MP3 file. FIG. 7 illustrates a standard layout of a ID3 tag. The ID3 tag includes a comment field. In embodiments of the ID3 tag, the comment field is 30 characters long. The Fair Share fingerprint is placed into this 30-character comment field.

Under certain operating conditions, the Fair Share fingerprint has a long, e.g., 68 character, string that is compressed to fit into the 30-character comment field. For example, the fingerprint may be structured as follows:

| | |
|---|---|
| Fair Share Unique Identifier | 8 characters long |
| Label Identifier | 8 characters long |
| Song Identifier | 10 characters long |
| User Identifier | 12 characters long |
| Padding | 30 characters long |

The song identifier is a unique ID for the CD that the digital music file is part of followed by a two-digit number identifying the track on the CD. The Fair Share media distribution system extracts the CD identifier embedded on the CD by the record company and then generates the song identifier.

The user identifier is updated by the Fair Share software whenever the digital music file passes from one owner to another, i.e., from the Fair Share web site to user1 or from user4 to user1. The combination of the song identifier and the user identifier are replicated in the Fair Share server, (in the music library database), which houses a database of all available music. The use of the digital fingerprint prevents a second user from taking the digital mucis file from a first user, put in on user 2's computer or system, and offer this to users through the Fair Share system or other file-sharing systems.

Illustratively, if the first user burns a Fair Share downloaded song to CD and gives that CD to the second user. The second user takes the CD and copies the song onto the user2 computer. The second user may attempt to make available the second song on the Fair Share digital music distribution system. However, the fingerprint that is on the song is still the fingerprint that identifies that the first user is the owner of the song. The Fair Share digital media distribution system recognizes that the fingerprint for the song belongs to the first user and will not allow the song to be either uploaded onto the system or to be made available for other users to download. In other words, the music library information database is not updated with the song being available from the second user.

If for some reason, assuming the same scenario, and assuming that the fingerprint has been compromised, the Fair Share digital music distribution system is still able to stop the second user from making the song available via the Fair Share web site In this scenario, when the second user logs into the Fair Share web site, the User Library Information database 136, runs a verification to make sure that the songs listed for the second user on the library information database matches the songs that are installed on the second user's computer. If this match is not made, the second user is identified as having an illegal or invalid song. In response to the match not being made, the song may not be listed, the second user may be banned from the system, or the second user may receive a warning.

Fair Share will be able to recommend customers with similar musical tastes to other customers, and encourage sharing in other ways such as setting up buddy lists or creating their own libraries or web sites. When customers log onto the Fair Share web site 120, their own home page will appear, located at http://www.fairshare.com/username. This homepage may be stored in the user account database 134 or the log database 138. This home page will contain a buddy list of people they know or chat with. It will also contain a list of recommended music based on their choices in the past. From the suggestion list, customers can get a list of users who are online at the moment and can offer the file for downloading. They can also see a list of other customers with similar taste so that they can browse those customers' files.

Although any business is subject to fraud, the Fair Share business model encourages users to share files legally because of the financial incentives. The fingerprint on a file identifies to Fair Share who has which files at any given time. It is possible for users wanting to circumvent the system to strip off the fingerprint; however, the file would then no longer be identified as a Fair Share file, so it could not be offered on the system and financial incentives would no longer be available.

For a user to “beat the system,” it would be necessary to 1) Break the encryption on the fingerprint; 2) Break into the server; 3) Break into the database and 4) Be familiar enough with the database schema to insert the information about where the file originated into the database. If users wish to “share” a file not in the Fair Share database, they would have to break into one of the servers and put the file onto it.

Finally, if the fingerprint is intact but the file is shared on another peer-to-peer file-sharing site, Fair Share can audit that site and locate its files on that system. It would also be able to use the fingerprint to track back to where illegal activities began.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A digital media file sharing system, comprising:
a fair share server including a user library information database and a media library, the media library storing digital media files;
a user computer including a user computer media library, the user computer media library storing user digital media files; and
a second user computer, including a second user computer media library, to request downloading of a selected digital media file from the user library information database, and to download the selected digital media file from the user computer media library, wherein
the user computer is allocated a credit in a payment database of the fair share server for providing the selected digital media file to the second user computer.

2. The digital media file sharing system of claim 1, further including an operator of the second user computer receiving a payment in the amount of the credit from the payment database.

3. The digital media file sharing system of claim 1, the fair share server including a log database, the log database to track activities of the second user computer when the second user computer is communicating with the fair share server.

4. The digital media file sharing system of claim 1, the fair share server including a market data database to track downloads completed by the second user.

5. The digital media file sharing system of claim 1, wherein a content provider is allocated a credit in the payment database and receives a payment in an amount of aggregated credits on a periodic basis.

6. The digital media file sharing system of claim 1, the fair share server including a user account database where the second user computer registers before downloading the selected digital media file from the user computer media library.

7. A method of loading information about a digital media file into a digital media distribution system, comprising:
loading a digital media file on a user computer;
verifying that the digital media file is compatible with the digital media distribution system; and
generating an identification code and placing the identification code into a header of the digital media file.

8. The method of claim 7 further including transmitting information regarding the digital media file to the digital media distribution system identifying that the digital media file is available for distribution.

9. The method of claim 8, further including receiving a download request for the digital media file from a second user computer.

10. The method of claim 9, further including transmitting the digital media file to the second user computer.

11. A method of searching for copyrighted digital media files on a digital media distribution system, comprising:
searching a user library information database for a copyrighted digital media file, wherein the user library information database includes information regarding digital media files stored on a digital media distribution system server and on at least one user computer media library;
receiving the at least one user computer media library as a storage location for the copyrighted digital media file; and
selecting the at least one user computer music library as a downloading site for the copyrighted digital media file.

12. The method of claim 11, further including downloading the copyrighted digital media file to a second user computer.

13. The method of claim 11, further including providing a payment to the digital media distribution system server to allow a download of the copyrighted digital media file and then downloading the copyrighted digital media file to the second user computer from the digital media distribution server.

14. The method of claim 13, further including verifying, at the second user computer, that the copyrighted digital media file has been successfully downloaded.

15. The method of claim 14, further including providing a credit in a payment database to a content provider for allowing the copyrighted digital media file to be utilized in the digital media distribution system.

16. The method of claim 14, further including providing a credit in a payment database to an operator of the at least one user computer for downloading the copyrighted digital media file to the second user computer.

17. The method of claim 11, further including registering with the digital media distribution system before receiving the at least one user computer media library as the storage location for the copyrighted digital media file.

18. A method of downloading a digital media file, comprising:
adding an identifier to the digital media file to identify the digital media file is a part of a digital media distribution system;
encrypting the identifier to create an encrypted digital media file to protect the digital media file from other users;
performing a hash of the digital media file to create a hash value, which is utilized to verify correct downloading of the file; and
encoding the digital media file to allow a user to choose an audio quality for the digital music file.

19. The method of claim 18, further including encrypting the encrypted digital media file utilizing a digital rights management scheme which is requested by a content provider.
